(19) United States
(12) Patent Application Publication
(10) Pub. No.: US 2007/0110162 A1
(43) Pub. Date: May 17, 2007

(54) 3-D morphological operations with adaptive structuring elements for clustering of significant coefficients within an overcomplete wavelet video coding framework

(76) Inventors: Deepak S. Turaga, Elmsford, NY (US); Mihaela Van Der Schaar, Sacremento, CA (US)

Correspondence Address: PHILIPS INTELLECTUAL PROPERTY & STANDARDS, P.O. BOX 3001, BRIARCLIFF MANOR, NY, 10510, US

(21) Appl. No.: 10/573,549

(22) PCT Filed: Sep. 24, 2004
(86) PCT No.: PCT/IB04/51859

§ 371 Date: Mar. 27, 2006

Related U.S. Application Data
(60) Provisional application No. 60/506,883, filed on Sep. 29, 2003.

(51) Int. Cl. H04B 1/66; H04N 7/12

(52) U.S. Cl. 375/240.19; 375/240.26

(57) ABSTRACT

A system and method is provided for digitally encoding video signals within an overcomplete wavelet video coder. Three dimensional morphological operations are used to identify clusters of significant wavelet coefficients. A video coding algorithm unit 365 locates significant wavelet coefficients across space and time. The video coding algorithm unit [365] also uses motion information to locate significant wavelet coefficients across space and time in a direction of motion. The lengths of a three dimensional structuring element [500] may be adaptively varied depending upon characteristics of the underlying video data. The invention increases coding efficiency and provides an increased quality of decoded video.

The present invention is directed, in general, to digital signal transmission systems and, more specifically, to a system and method for employing three dimensional (3-D) morphological significant coding techniques to grow clusters of significant coefficients across both space and time within an overcomplete wavelet video coding framework.

In digital video communications overcomplete wavelet video coding provides a very flexible and efficient framework for video transmission. Overcomplete wavelet video coding may be considered to be a generalization of previously existing interframe wavelet encoding techniques. By performing motion compensated temporal filtering, independently subband by subband, after the spatial decomposition in the overcomplete wavelet domain, problems with shift variance of the wavelet transform can be resolved.

Morphological significance map coding has been introduced for image coding where significant wavelet coefficients are clustered together using morphological operations. Two dimensional (2-D) morphological operations have been used to cluster significant wavelet coefficients and predict significance across different spatial scales. The morphological operations have been shown to be more robust in preserving important features like edges.

Previously existing applications of morphological significance coding to video consider different frames as independent images or independent residue frames. Therefore the prior art approaches do not efficiently exploit inter-frame dependencies.

There is therefore a need in the art for a system and method that is capable of applying morphological significance operations to video coding to provide an increase in coding efficiency. There is also a need in the art for a system and method that is capable of applying morphological significance operations to video coding to provide an increase in the quality of decoded video of wavelet based video coding schemes.

To address the deficiencies of the prior art mentioned above, the system and method of the present invention applies three dimensional (3-D) morphological significance coding techniques to video coding. The system and method of the present invention is capable of growing clusters of significant wavelet coefficients across space and time.

The system and method of the present invention comprises a video coding algorithm unit that is located within a video encoder of a video transmitter. The video coding algorithm unit is capable of locating significant wavelet coefficients in at least one cluster of significant wavelet coefficients across space and time. The video coding algorithm unit of the invention searches a subband until the video coding algorithm finds a first significant wavelet coefficient in a current frame. The video coding algorithm unit then employs a three dimensional (3-D) morphological significance coding technique to locate additional significant wavelet coefficients in a cluster of significant wavelet coefficients.

The video coding algorithm unit of the invention aligns a three dimensional structuring element on the first significant wavelet coefficient that is located in the current video frame and then searches for additional significant wavelet coefficients within the three dimensional structuring element.

In one advantageous embodiment of the invention the video coding algorithm unit (1) aligns a centrally located portion of a first section of the three dimensional structuring element on the first significant wavelet coefficient that is located in the current video frame, and (2) aligns a second section of the three dimensional structuring element on a next frame after the current frame, and (3) aligns a third section of the three dimensional structuring element on a prior frame before the current frame. The video coding algorithm unit searches for additional significant wavelet coefficients within each of the three sections of the three dimensional structuring element.

In another advantageous embodiment of the system and method of the invention, the video coding algorithm unit uses a motion vector from the current frame to the next frame to align the second section of the three dimensional structuring element on the next frame after the current frame. The video coding algorithm unit also uses a motion vector from the current frame to the previous frame to align the third section of the three dimensional structuring element on the previous frame before the current frame.

In yet another advantageous embodiment of the system of the invention, the video coding algorithm unit is capable of adaptively changing the size of the three dimensional structuring element to take advantage of the characteristics of the underlying video data.

It is an object of the present invention to provide a system and method for employing a three dimensional (3-D) morphological significance coding technique to video coding.

It is another object of the present invention to provide a system and method in a digital video transmitter for digitally encoding video signals within an overcomplete wavelet video coding framework for locating clusters of significant wavelet coefficients across space and time.

It is also an object of the present invention to provide a system and method in a digital video transmitter for digitally encoding video signals within an overcomplete wavelet video coding framework for locating clusters of significant wavelet coefficients across space and time in a direction of motion.

It is another object of the present invention to provide a three dimensional (3-D) morphological structuring element.

It is also an object of the present invention to provide a system and method for adaptively changing the size of a three dimensional (3-D) morphological structuring element to take advantage of the characteristics of underlying video data.

The foregoing has outlined rather broadly the features and technical advantages of the present invention so that those skilled in the art may better understand the detailed description of the invention that follows. Additional features and advantages of the invention will be described hereinafter that form the subject of the claims of the invention. Those skilled in the art should appreciate that they may readily use the conception and the specific embodiment disclosed as a basis for modifying or designing other structures for carrying out the same purposes of the present invention. Those skilled in the art should also realize that such equivalent constructions do not depart from the spirit and scope of the invention in its broadest form.

Before undertaking the Detailed Description of the Invention, it may be advantageous to set forth definitions of certain words and phrases used throughout this patent document: the terms “include” and “comprise” and derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller,” “processor,” or “apparatus” means any device, system or part thereof that controls at least one operation, such a device may be implemented in hardware, firmware or software, or some combination of at least two of the same. It should be noted that the functionality associated with any particular controller may be centralized or distributed, whether locally or remotely. In particular, a controller may comprise one or more data processors, and associated input/output devices and memory, that execute one or more application programs and/or an operating system program. Definitions for certain words and phrases are provided throughout this patent document. Those of ordinary skill in the art should understand that in many, if not most instances, such definitions apply to prior uses, as well as future uses, of such defined words and phrases.

For a more complete understanding of the present invention, and the advantages thereof, reference is now made to the following descriptions taken in conjunction with the accompanying drawings, wherein like numbers designate like objects, and in which:

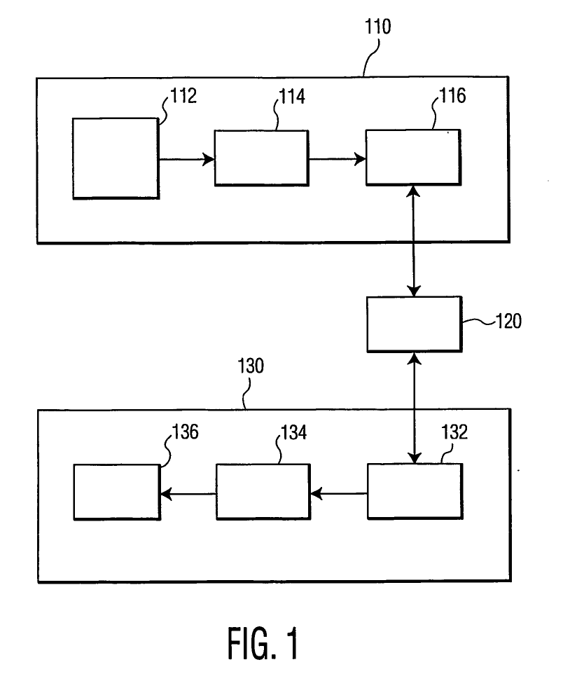

FIG. 1 is a block diagram illustrating an end-to-end transmission of streaming video from a streaming video transmitter through a data network to a streaming video receiver according to an advantageous embodiment of the present invention;

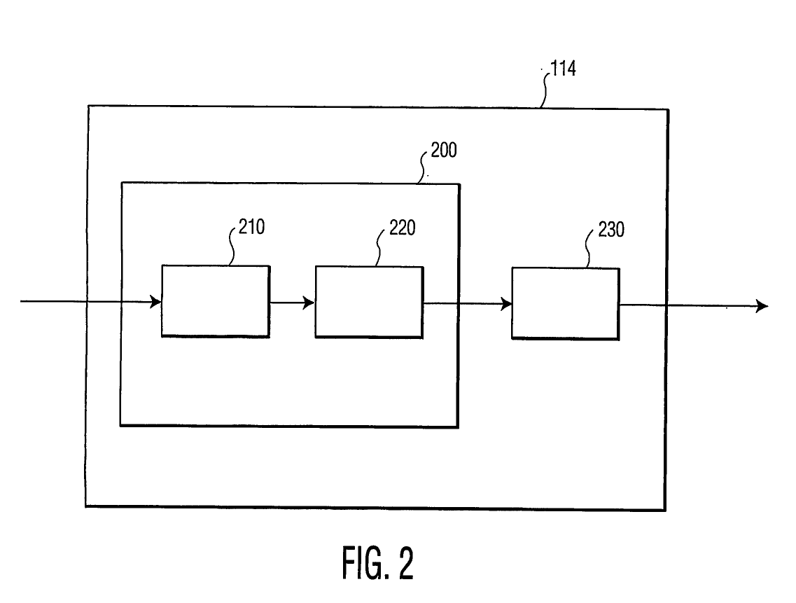

FIG. 2 is a block diagram illustrating an exemplary video encoder according to an advantageous embodiment of the present invention;

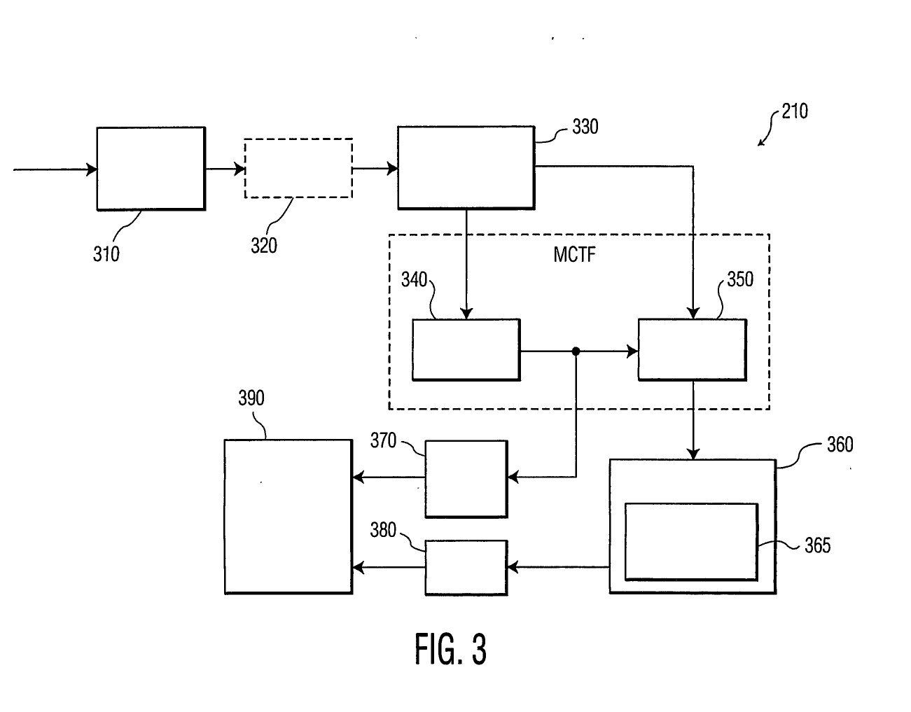

FIG. 3 is a block diagram an exemplary overcomplete wavelet coder according to an advantageous embodiment of the present invention;

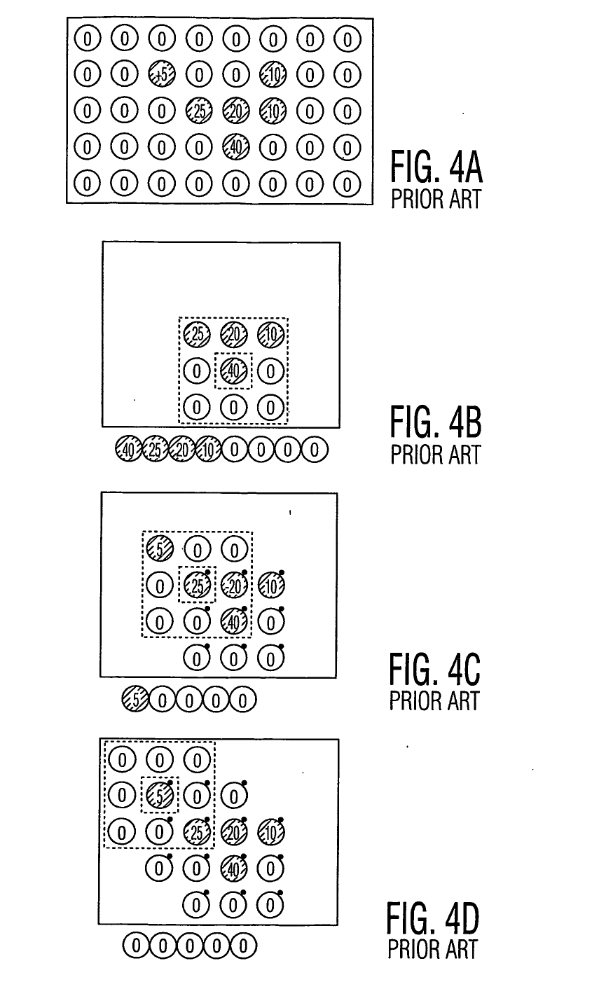

FIG. 4 is a diagram illustrating a prior art method for using a two dimensional (2-D) morphological significance map to locate clusters of significant wavelet coefficients;

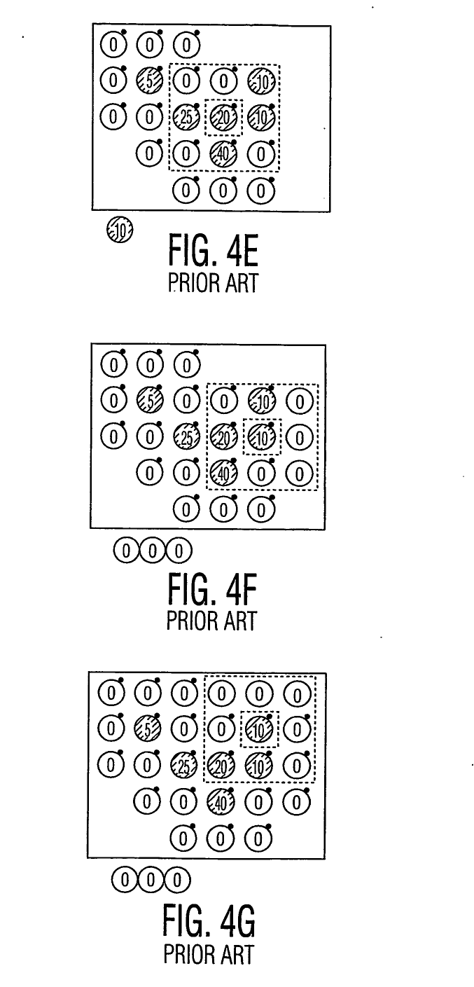

FIG. 5 illustrates an exemplary 3-D morphological structuring element in accordance with an advantageous embodiment of the present invention;

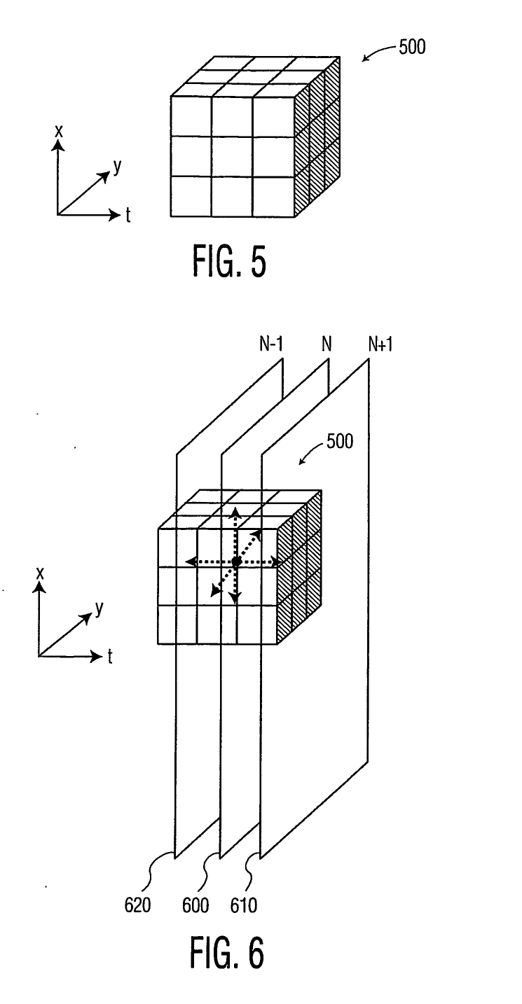

FIG. 6 illustrates how a 3-D morphological structuring element of the present invention may be used to grow a cluster of significant coefficients across space and time;

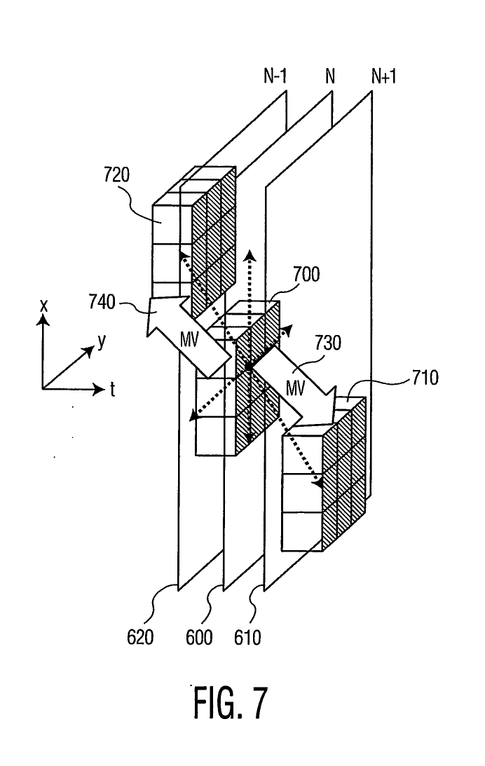

FIG. 7 illustrates how a 3-D morphological structuring element of the present invention may be used to grow a cluster of significant coefficients across space and time in a direction of motion;

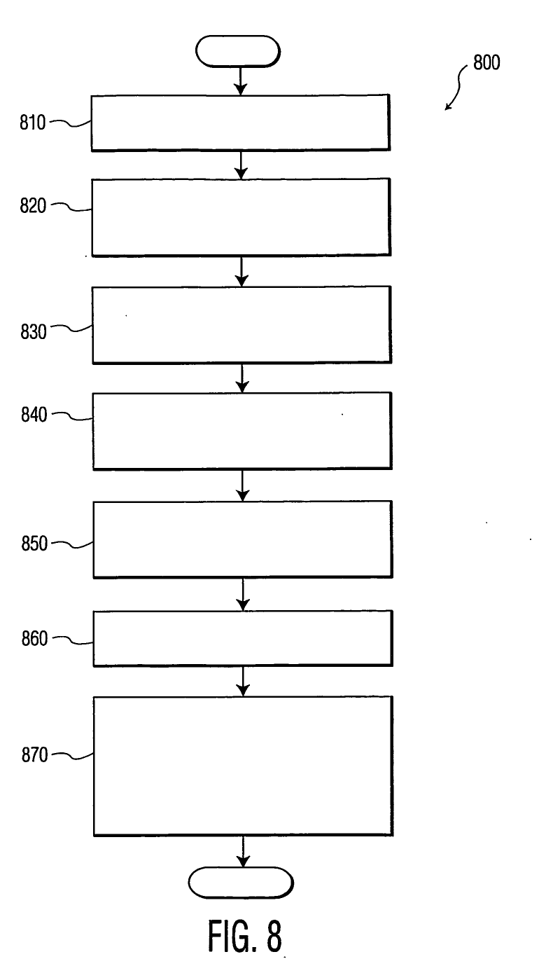

FIG. 8 illustrates a flowchart showing the steps of a first method of an advantageous embodiment of the present invention;

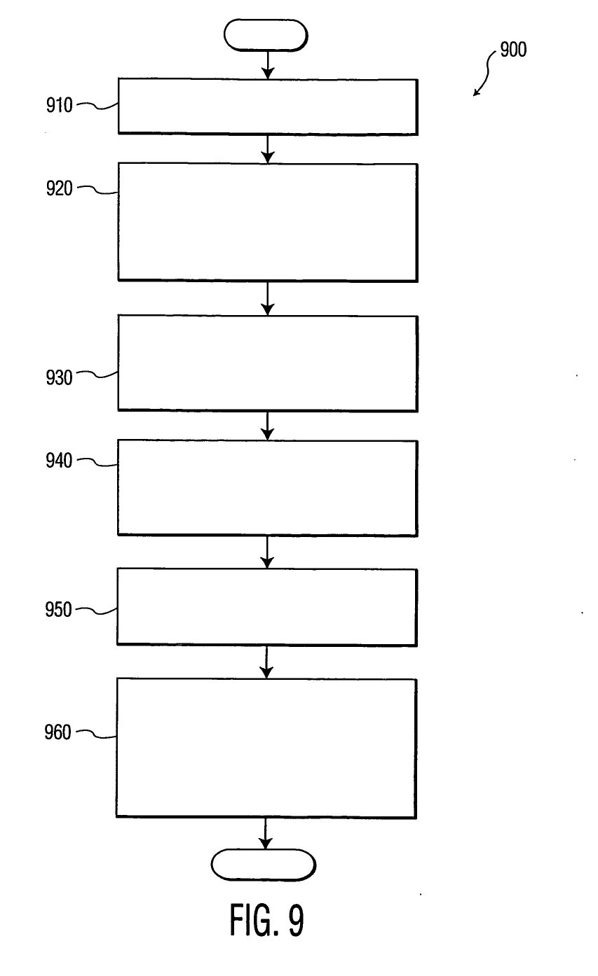

FIG. 9 illustrates a flowchart showing the steps of a second method of an advantageous embodiment of the present invention; and

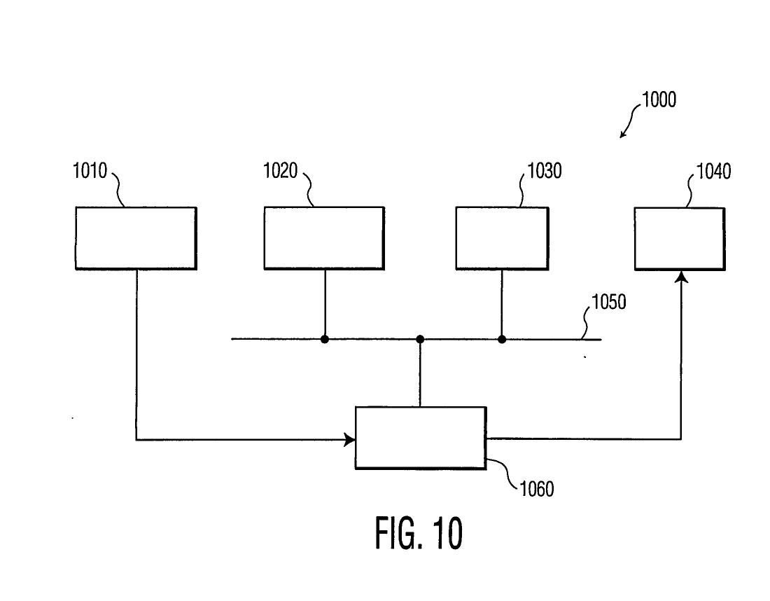

FIG. 10 illustrates an exemplary embodiment of a digital transmission system that may be used to implement the principles of the present invention.

FIGS. 1 through 10, discussed below, and the various embodiments used to describe the principles of the present invention in this patent document are by way of illustration only and should not be construed in any way to limit the scope of the invention. The present invention may be used in any digital video signal encoder or transcoder.

FIG. 1 is a block diagram illustrating an end-to-end transmission of streaming video from streaming video transmitter 110, through data network 120 to streaming video receiver 130, according to an advantageous embodiment of the present invention. Depending on the application, streaming video transmitter 110 may be any one of a wide variety of sources of video frames, including a data network server, a television station, a cable network, a desktop personal computer (PC), or the like.

Streaming video transmitter 110 comprises video frame source 112, video encoder 114 and encoder buffer 116. Video frame source 112 may be any device capable of generating a sequence of uncompressed video frames, including a television antenna and receiver unit, a video cassette player, a video camera, a disk storage device capable of storing a “raw” video clip, and the like. The uncompressed video frames enter video encoder 114 at a given picture rate (or “streaming rate”) and are compressed according to any known compression algorithm or device, such as an MPEG-4 encoder. Video encoder 114 then transmits the compressed video frames to encoder buffer 116 for buffering in preparation for transmission across data network 120. Data network 120 may be any suitable IP network and may include portions of both public data networks, such as the Internet, and private data networks, such as an enterprise owned local area network (LAN) or wide area network (WAN).

Streaming video receiver 130 comprises decoder buffer 132, video decoder 134 and video display 136. Decoder buffer 132 receives and stores streaming compressed video frames from data network 120. Decoder buffer 132 then transmits the compressed video frames to video decoder 134 as required. Video decoder 134 decompresses the video frames at the same rate (ideally) at which the video frames were compressed by video encoder 114. Video decoder 134 sends the decompressed frames to video display 136 for play-back on the screen of video display 136.

FIG. 2 is a block diagram illustrating an exemplary video encoder 114 according to an advantageous embodiment of the present invention. Exemplary video encoder 114 comprises source coder 200 and transport coder 230. Source coder 200 comprises waveform coder 210 and entropy coder 220. Video signals are provided from video frame source 112 (shown in FIG. 1) to source coder 200 of video encoder 114. The video signals enter waveform coder 210 where they are processed in accordance with the principles of the present invention in a manner that will be more fully described.

Waveform coder 210 is a lossy device that reduces the bitrate by representing the original video using transformed variables and applying quantization. Waveform coder 210 may perform transform coding using a discrete cosine transform (DCT) or a wavelet transform. The encoded video signals from waveform coder 210 are then sent to entropy coder 220.

Entropy coder 220 is a lossless device that maps the output symbols from waveform coder 210 into binary code words according to a statistical distribution of the symbols to be coded. Examples of entropy coding methods include Huffman coding, arithmetic coding, and a hybrid coding method that uses DCT and motion compensated prediction. The encoded video signals from entropy coder 220 are then sent to transport coder 230.

Transport coder 230 represents a group of devices that perform channel coding, packetization and/or modulation, and transport level control using a particular transport protocol. Transport coder 230 coverts the bit stream from source coder 200 into data units that are suitable for transmission. The video signals that are output from transport coder 230 are sent to encoder buffer 116 for ultimate transmission through data network 120 to video receiver 130.

FIG. 3 is a block diagram illustrating an exemplary overcomplete wavelet coder 210 according to an advantageous embodiment of the present invention. Overcomplete wavelet coder 210 comprise a branch that comprises a discrete wavelet transform unit 310 that generates a wavelet transform of a current frame 320, and a complete to overcomplete discrete wavelet transform unit 330. A first output of complete to overcomplete discrete wavelet transform unit 330 is provided to motion estimation unit 340. A second output of complete to overcomplete discrete wavelet transform unit 330 is provided to temporal filtering unit 350. Together motion estimation unit 340 and temporal filtering unit 350 provide motion compensated temporal filtering (MCTF). Motion estimation unit 340 provides motion vectors (and frame reference numbers) to temporal filtering unit 350.

Motion estimation unit 340 also provides motion vectors (and frame reference numbers) to motion vector coder unit 370. The output of motion vector coder unit 370 is provided to transmission unit 390. The output of temporal filtering unit 350 is provided to subband coder 360. Subband coder 360 comprises video coding algorithm unit 365. Video coding algorithm unit 365 comprises an exemplary structure for operating the video coding algorithm of the present invention. The output of subband coder 360 is provided to entropy coder 380. The output of entropy coder 380 is provided to transmission unit 390. The structure and operation of the other various elements of overcomplete wavelet coder 210 are well known in the art.

To better understand the operation of the video coding algorithm of the present invention, a description of a prior art two-dimensional (2-D) video coding algorithm will first be described. FIG. 4 illustrates a simple numerical example of two dimensional (2-D) morphological significance map for locating clusters of significant wavelet coefficients.

In the prior art two dimensional (2-D) process, an encoder scans a subband in a raster scan order until the encoder locates a significant wavelet coefficient (i.e., a non-zero wavelet coefficient). The encoder then looks for other significant wavelet coefficients within a specific region surrounding the first significant wavelet coefficients. In the example shown in FIG. 4, the specific region comprises the nearest eight (8) wavelet coefficient neighbors located within a structuring element comprising a three (3) by three (3) square centered on the first significant wavelet coefficient.

If a neighboring coefficient is zero (i.e., non-significant) it is ignored. If a neighboring coefficient is non-zero (i.e., significant), then the process is applied recursively to each of the new values that are found. When all of the significant coefficients in a cluster have been found using the recursively applied process, the raster scanning of insignificant coefficients resumes until all of the subband has been scanned. This process is sometimes referred to as morphological dilation. The morphological dilation process is capable of capturing all of the clusters of significant coefficients in a subband.

FIG. 4 provides an example of the operation of the two dimensional (2-D) morphological dilation process. Suppose the set of coefficients in the block shown in FIG. 4(a) is to be encoded. The block comprises six (6) significant coefficients and thirty four (34) non-significant (i.e., zero) coefficients in a five (5) by eight (8) block of coefficients. A structuring element of a three (3) by three (3) block is placed at the coefficient whose value is forty (40). FIG. 4(b) shows that the significant coefficients within located within the structuring element have the values twenty five (25), minus twenty (−20), and ten (10). The line of coefficients under FIG. 4(b) shows the coefficients that are located within the structuring element when it is centered on coefficient forty (40). These coefficients are transmitted as the coefficients obtained at the first step of the process.

The structuring element is then moved so that it is centered on coefficient twenty five (25). This location is illustrated in FIG. 4(c). The only new significant coefficient that has not already been recorded has the value minus five (−5). The coefficient with the value minus five (−5) and the four (4) new zero coefficients are shown in the line of coefficients under FIG. 4(c). These coefficients are transmitted as the coefficients obtained at the second step of the process. The small black dots next to a coefficient are used to indicate those coefficients that have already been transmitted and therefore do not need to be retransmitted.

The structuring element is then moved so that it is centered on coefficient minus five (−5). This location is illustrated in FIG. 4(d). FIGS. 4(d) through 4(g) illustrate how the process is continued to grow the coefficient cluster region by applying the dilation operator centered at each significant coefficient in the set. The dilation process has detected all of the significant coefficients in the block by the time the process has completed the scan as shown in FIG. 4(g).

Two dimensional (2-D) morphological significance coding has previously been applied to video. An example is set forth and described in a paper by J. Vass et al. entitled “Significance-Linked Connected Component Analysis for Very Low Bit-Rate Wavelet Video Coding,” published in IEEE Transactions on Circuits and Systems for Video Technology, Volume 9, Pages 630-647, June 1999. The Vass system first applies a temporal filter and then clusters the temporally filtered frames by using a two dimensional (2-D) morphological significance coding. The Vass system considers the different video frames as independent images or independent residue frames. The Vass system does not efficiently exploit inter-frame dependencies.

Other prior art systems have applied similar morphological significance coding techniques. See, for example, a paper by S. D. Servetto et al. entitled “Image Coding Based on a Morphological Representation of Wavelet Data,” published in IEEE Transactions on Circuits and Systems for Video Technology, Volume 8, Pages 1161-1174, September 1999.

In contrast to the prior art, the present invention is capable of employing three dimensional (3-D) morphological significance coding techniques. As will be more fully described, the system and method of the present invention is capable of growing clusters of significant wavelet coefficients across both space and time. The video coding algorithm of the present invention (1) increases coding efficiency, and (2) increases the decoded video quality of wavelet based video coding schemes.

FIG. 5 illustrates an advantageous embodiment of an exemplary three dimensional (3-D) structuring element 500 in accordance with the principles of the present invention. Structuring element 500 represents a three dimensional (3-D) cube that is subdivided into three blocks on each side of the cube. Each block corresponds to a single pixel. There are twenty seven (27) such blocks (i.e., three (3) cubed) within structuring element 500. As shown in FIG. 5, structuring element 500 extends in an “x” direction (a spatial direction), and in a “y” direction (a spatial direction), and in a “t” direction (a temporal direction). The orientation of the (x,y,t) coordinate system is also shown in FIG. 5.

When structuring element 500 is placed in operation the centrally located block (not shown in FIG. 5) in structuring element 500 is located on a first significant wavelet coefficient This means that there will be twenty six (26) neighboring locations around the centrally located block that must be considered.

FIG. 6 illustrates one advantageous embodiment of how three dimensional (3-D) structuring element 500 may be used to grow a cluster of significant wavelet coefficients across space and time. The centrally located block (identified in FIG. 6 with a small dark sphere) is located on a first significant wavelet coefficient in current frame 600. Current frame 600 is also designated as Frame N. There are eight (8) neighboring blocks in frame 600 that surround the centrally located block in frame 600. The centrally located block and the eight (8) neighboring blocks in frame 600 comprise a first section of structuring element 500.

In the next frame 610 there are nine (9) neighboring blocks that may be accessed from the centrally located block in frame 600. Next frame 610 is also designated as Frame N+1. The nine (9) neighboring blocks in the next frame 610 make up a second section of structuring element 500. Similarly, in the previous frame 620 there are nine (9) neighboring blocks that may be accessed from the centrally located block in frame 600. Previous frame 620 is also designated as Frame N−1. The nine (9) neighboring blocks in the previous frame 620 make up a third section of structuring element 500.

The video coding algorithm of the present invention employs a three dimensional (3-D) morphological significance coding technique to find and cluster other significant wavelet coefficients around the first significant wavelet coefficient. In particular, the algorithm searches the eight (8) neighboring blocks around the centrally located block in the current frame 600, and the nine (9) neighboring blocks in the next frame 610, and the nine (9) neighboring blocks in the previous frame 620. The algorithm is thereby able to grow the cluster of significant wavelet coefficients across both space and time. The use of structuring element 500 as previously described represents a direct extension of a morphological significance coding technique into the third dimension (i.e., the temporal dimension).

The direct extension method described with reference to FIG. 5 and FIG. 6 may be enhanced by utilizing motion information. It is known that motion exists between the frames and that the motion is identified during the motion estimation process. The efficiency of the direct extension method may be increased by modifying the structuring element to take the motion information into account.

FIG. 7 illustrates one advantageous embodiment of the invention showing how three dimensional (3-D) structuring element 500 may be used to grow a cluster of significant wavelet coefficients across both space and time in a direction of motion. Structuring element 500 is divided into three sections. A first section of structuring element 500 comprises the central section of structuring element 500 within current frame 600. The first section is designated with reference numeral 700. The centrally located block (identified in FIG. 7 with a small dark sphere) is located on a first significant wavelet coefficient in current frame 600. Current frame 600 is also designated as Frame N. There are eight (8) neighboring blocks in frame 600 that surround the centrally located block in frame 600. The centrally located block and the eight (8) neighboring blocks make up the first section 700.

The second section of structuring element 500 comprises a detached three (3) block by three (3) block section of structuring element 500 within next frame 610. The second section is designated with reference numeral 710. In second section 710 there are nine (9) neighboring blocks that may be accessed from the centrally located block in first section 700. The displacement of second section 710 from first section 700 is measured by motion vector 730. That is, the magnitude and direction of motion vector 730 between current frame 600 and next frame 610 is used to locate second section 710 with respect to first section 700. The morphological significance coding is performed within second section 710 at the motion compensated location.

Similarly, the third section of structuring element 500 comprises a detached three (3) by three (3) block section of structuring element 500 within previous frame 620. The third section is designated with reference numeral 720. In third section 720 there are nine (9) neighboring blocks that may be accessed from the centrally located block in first section 700. The displacement of third section 720 from first section 700 is measured by motion vector 740. That is, the magnitude and direction of motion vector 740 between current frame 600 and previous frame 620 is used to locate third section 720 with respect to first section 700. The morphological significance coding is performed within third section 720 at the motion compensated location.

When the motion vectors (730, 740) are equal to zero, then the motion vector method shown in FIG. 7 reduces to the direct extension method shown in FIG. 5 and in FIG. 6.

The advantage of growing the wavelet coefficient clusters across space and time in the direction of motion is that is provides a very efficient representation for the morphological significance map. This provides a corresponding increase in the coding performance. The data may then be subsequently coded using standard entropy coding techniques. The process may be repeated bitplane by bitplane for embedded coding.

In the advantageous embodiments of the invention described above, structuring element 500 had a fixed size of three (3) blocks by three (3) blocks by three (3) blocks, all of uniform size. In alternate embodiments of the invention, the size of the structuring element can be changed adaptively in all three dimensions to take advantage of the characteristics of the underlying data. In general, the size of the structuring element may be defined to be a rectangular volume having a length of Nₓ in a first spatial direction (“x”), and a length of N_{y} in a second spatial direction (“y”), and a length of Nₜ in a temporal direction (“t”). The three values (i.e., Nₓ and N_{y} and Nₜ) may be varied adaptively depending upon the characteristics of the underlying data.

Consider a case in which the temporal size of the structuring element is based on motion information. First, if the underlying motion is small, then the value of Nₜ can be increased. The underlying motion may be considered to be small (1) if the absolute value of the motion vector in the x direction is less than or equal to two, and (2) if the absolute value of the motion vector in the y direction is less than or equal to two.

Second, if the underlying motion is very regular, then the value of Nₜ can be increased. The underlying motion may be considered to be very regular (1) if the variance of the motion vector in the x direction is less than or equal to a threshold T, and (2) if the variance of the motion vector in the y direction is less than or equal to the threshold T. The threshold T may be chosen based on the characteristics of the video sequence.

Third, in the example shown in FIG. 7 the structuring element (700, 710, 720) is bi-directional in time. If, however, uni-directional motion estimation is performed, then the structuring element must also be unidirectional (i.e., asymmetric).

Fourth, in the example shown in FIG. 7 the structuring element (700, 710, 720) is in three sections. If, however, multiple reference frames are used, then the structuring element must also be modified to accommodate the use of multiple reference frames. For example, if in one embodiment five (5) frames were used, the five (5) frames would be designated N−2, N−1, N, N+1 and N+2. There would be one current frame N, two prior frames, N−2 and N−1, and two next frames, N+1 and N+2.

Now consider a case in which the spatial size of the structuring element is adapted based on spatial characteristics of the data. First, if the underlying data consists of long horizontal clusters, then size of Nₓ may be increased while the size of N_{y} may be decreased. Second, if the underlying data consists of long vertical clusters, then size of N_{y} may be increased while the size of Nₓ may be decreased.

Third, if the subbands under consideration correspond to coarse scales, then smaller values of Nₓ and N_{y} must be used. Fourth, if the subbands under consideration correspond to fine scales, then larger values of Nₓ and N_{y} must be used.

FIG. 8 illustrates a flowchart showing the steps of a first method of an advantageous embodiment of the present invention. The steps are collectively referred to with reference numeral 800. In the first step of the method the video coding algorithm of the present invention scans a subband in a raster scan order until a first significant wavelet coefficient is located in a current frame (step 810). Then the video coding algorithm aligns a central block of a three dimensional (3-D) structuring element 500 on the first significant wavelet coefficient (step 820). The algorithm then searches for additional significant wavelet coefficients in the neighboring blocks of the first section of structuring element 500 in the current frame (step 830).

The algorithm then searches for additional significant wavelet coefficients in the neighboring blocks of the second section of structuring element 500 in the next frame (step 840). The algorithm then searches for additional significant wavelet coefficients in the neighboring blocks of the third section of structuring element 500 in the previous frame (step 850). The algorithm then identifies all of the significant wavelet coefficients that have been located in all of the neighboring blocks (step 860).

The algorithm then sequentially re-aligns structuring element 500 on each of the identified significant wavelet coefficients and repeats the search process for each significant wavelet coefficient until all significant wavelet coefficients in the cluster have been located (step 870).

FIG. 9 illustrates a flowchart showing the steps of a second method of an advantageous embodiment of the present invention. The steps are collectively referred to with reference numeral 900. In the first step of the method the video coding algorithm of the present invention scans a subband in a raster scan order until a first significant wavelet coefficient is located in a current frame (step 910). Then the video coding algorithm aligns a central block of a first section of a three dimensional (3-D) structuring element 500 on the first significant wavelet coefficient in the current frame and performs a search of the neighboring blocks in the first section for additional significant wavelet coefficients (step 920).

The algorithm then aligns a second section of the three dimensional (3-D) structuring element 500 in the next frame using a motion vector from the current frame to the next frame and performs a search of the neighboring blocks in the second section for additional significant wavelet coefficients (step 930).

The algorithm then aligns a third section of the three dimensional (3-D) structuring element 500 in the previous frame using a motion vector from the current frame to the previous frame and performs a search of the neighboring blocks in the third section for additional significant wavelet coefficients (step 940).

The algorithm then identifies all of the significant wavelet coefficients that have been located in all of the neighboring blocks (step 950).

The algorithm then sequentially re-aligns structuring element 500 on each of the identified significant wavelet coefficients and repeats the search process for each significant wavelet coefficient (including aligning the second and third sections of structuring element 500 using motion vectors) until all significant wavelet coefficients in the cluster have been located (step 960).

FIG. 10 illustrates an exemplary embodiment of a system 1000 which may be used for implementing the principles of the present invention. System 1000 may represent a television, a set-top box, a desktop, laptop or palmtop computer, a personal digital assistant (PDA), a video/image storage device such as a video cassette recorder (VCR), a digital video recorder (DVR), a TiVO device, etc., as well as portions or combinations of these and other devices. System 1000 includes one or more video/image sources 1010, one or more input/output devices 1060, a processor 1020 and a memory 1630. The video/image source(s) 1010 may represent, e.g., a television receiver, a VCR or other video/image storage device. The video/image source(s) 1010 may alternatively represent one or more network connections for receiving video from a server or servers over, e.g., a global computer communications network such as the Internet, a wide area network, a terrestrial broadcast system, a cable network, a satellite network, a wireless network, or a telephone network, as well as portions or combinations of these and other types of networks.

The input/output devices 1060, processor 1020 and memory 1030 may communicate over a communication medium 1050. The communication medium 1050 may represent, e.g., a bus, a communication network, one or more internal connections of a circuit, circuit card or other device, as well as portions and combinations of these and other communication media Input video data from the source(s) 1010 is processed in accordance with one or more software programs stored in memory 1030 and executed by processor 1020 in order to generate output video/images supplied to a display device 1040.

In a preferred embodiment, the coding and decoding employing the principles of the present invention may be implemented by computer readable code executed by the system. The code may be stored in the memory 1030 or read/downloaded from a memory medium such as a CD-ROM or floppy disk. In other embodiments, hardware circuitry may be used in place of, or in combination with, software instructions to implement the invention. For example, the elements illustrated herein may also be implemented as discrete hardware elements.

While the present invention has been described in detail with respect to certain embodiments thereof, those skilled in the art should understand that they can make various changes, substitutions modifications, alterations, and adaptations in the present invention without departing from the concept and scope of the invention in its broadest form.

1. An apparatus [365] in a digital video transmitter [110] for digitally encoding video signals within an overcomplete wavelet video coder [210], said apparatus [365] comprising a video coding algorithm unit [365] that is capable of locating significant wavelet coefficients in at least one cluster of significant wavelet coefficients across space and time.

2. An apparatus [365] as claimed in claim 1 wherein said video coding algorithm unit [365] is capable of applying a three dimensional morphological significance coding technique to locate said significant wavelet coefficients.

3. An apparatus [365] as claimed in claim 2 wherein said video coding algorithm unit [365] aligns a three dimensional structuring element [500] on a first significant wavelet coefficient that is located in a current video frame [600]; and
wherein said video coding algorithm unit [365] searches for additional significant wavelet coefficients within said three dimensional structuring element [500].

4. An apparatus [365] as claimed in claim 3 wherein said video coding algorithm unit [365] aligns a centrally located portion of a first section of said three dimensional structuring element [500] on said first significant wavelet coefficient that is located in said current video frame [600]; and
wherein said video coding algorithm unit [365] aligns a second section of said three dimensional structuring element [500] on a next frame [610] after said current frame [600]; and
wherein said video coding algorithm unit [365] aligns a third section of said three dimensional structuring element [500] on a prior frame [620] before said current frame [600].

5. An apparatus [365] as claimed in claim 4 wherein said video coding algorithm unit [365] uses motion information [730] to align said second section [710] of said three dimensional structuring element [500] on said next frame [610] and uses motion information [740] to align said third section [720] of said three dimensional structuring element [500] on said previous frame [620].

6. An apparatus [365] as claimed in claim 3 wherein said three dimensional structural element [500] comprises a rectangular shape having a length of Nₓ in a first spatial dimension, and a length of N_{y} in a second spatial dimension, and a length of Nₜ in a temporal dimension; and
wherein each of said lengths Nₓ, N_{y} and Nₜ of said three dimensional structuring element [500] may be varied adaptively depending upon characteristics of underlying video data.

7. An apparatus [365] as claimed in claim 6 wherein said three dimensional structuring element [500] may be divided into a plurality of sections greater than three to accommodate the use of multiple reference frames.

8. An apparatus [365] as claimed in claim 6 wherein said three dimensional structuring element [500] is unidirectional in a temporal dimension to accommodate unidirectional motion estimation.

9. An apparatus [365] as claimed in claim 1 wherein said video coding algorithm unit [365] is capable of locating significant wavelet coefficients in at least one cluster of significant wavelet coefficients across space and time in a direction of motion.

10. A method for digitally encoding video signals within an overcomplete wavelet video coder [210] in a digital video transmitter [110], said method comprising the steps of:
detecting a first significant wavelet coefficient in a current video frame 600; and
locating additional significant wavelet coefficients in a cluster of significant wavelet coefficients across space and time.

11. A method as claimed in claim 10 further comprising the step of:
applying a three dimensional morphological significance coding technique to locate said additional significant wavelet coefficients in said cluster of significant wavelet coefficients.

12. A method as claimed in claim 11 further comprising the steps of:
aligning a three dimensional structuring element [500] on said first significant wavelet coefficient that is located in said current video frame [600]; and
searching for said additional significant wavelet coefficients within said three dimensional structuring element [500].

13. A method as claimed in claim 12 further comprising the steps of:
aligning a centrally located portion of a first section of said three dimensional structuring element [500] on said first significant wavelet coefficient that is located in said current video frame [600]; and
aligning a second section of said three dimensional structuring element [500] on a next frame [610] after said current frame [600]; and
aligning a third section of said three dimensional structuring element [500] on a prior frame [620] before said current frame [600].

14. A method as claimed in claim 13 further comprising the steps of:
using motion information [730] to align said second section [710] of said three dimensional structuring element [500] on said next frame [610]; and
using motion information [740] to align said third section [720] of said three dimensional structuring element [500] on said previous frame [620].

15. A method as claimed in claim 12 wherein said three dimensional structural element [500] comprises a rectangular shape having a length of Nₓ in a first spatial dimension, and a length of N_{y} in a second spatial dimension, and a length of Nₜ in a temporal dimension; and said method further comprises the step of:
adaptively varying each of said lengths Nₓ, N_{y} and Nₜ of said three dimensional structuring element 500 depending upon characteristics of underlying video data.

16. A method as claimed in claim 15 further comprising the step of:
dividing said three dimensional structuring element [500] into a plurality of sections greater than three to accommodate the use of multiple reference frames.

17. A method as claimed in claim 15 wherein said three dimensional structuring element [500] is unidirectional in a temporal dimension to accommodate unidirectional motion estimation.

18. A method as claimed in claim 10 further comprising the step of locating significant wavelet coefficients in at least one cluster of significant wavelet coefficients across space and time in a direction of motion.

19. A digitally encoded video signal generated by a method for digitally encoding video signals within an overcomplete wavelet video coder [210] in a digital video transmitter [110], said method comprising the steps of:
detecting a first significant wavelet coefficient in a current video frame 600; and
locating additional significant wavelet coefficients in a cluster of significant wavelet coefficients across space and time.

20. A digitally encoded video signal as claimed in claim 19 wherein said method further comprises the step of:
applying a three dimensional morphological significance coding technique to locate said additional significant wavelet coefficients in said cluster of significant wavelet coefficients.

21. A digitally encoded video signal as claimed in claim 20 wherein said method further comprises the steps of:
aligning a three dimensional structuring element [500] on said first significant wavelet coefficient that is located in said current video frame [600]; and
searching for said additional significant wavelet coefficients within said three dimensional structuring element [500].

22. A digitally encoded video signal as claimed in claim 21 wherein said method further comprises the steps of:
aligning a centrally located portion of a first section of said three dimensional structuring element [500] on said first significant wavelet coefficient that is located in said current video frame [600]; and
aligning a second section of said three dimensional structuring element [500] on a next frame [610] after said current frame [600]; and
aligning a third section of said three dimensional structuring element [500] on a prior frame [620] before said current frame [600].

23. A digitally encoded video signal as claimed in claim 22 wherein said method further comprises the steps of:
using motion information [730] to align said second section [710] of said three dimensional structuring element [500] on said next frame [610]; and
using motion information [740] to align said third section [720] of said three dimensional structuring element [500] on said previous frame [620].

24. A digitally encoded video signal as claimed in claim 21 wherein said three dimensional structural element [500] comprises a rectangular shape having a length of Nₓ in a first spatial dimension, and a length of N_{y} in a second spatial dimension, and a length of Nₜ in a temporal dimension; and said method further comprises the step of:
adaptively varying each of said lengths Nₓ, N_{y} and Nₜ of said three dimensional structuring element [500] depending upon characteristics of underlying video data.

25. A digitally encoded video signal as claimed in claim 22 wherein said method further comprises the step of:
dividing said three dimensional structuring element [500] into a plurality of sections greater than three to accommodate the use of multiple reference frames.

26. A digitally encoded video signal as claimed in claim 22 wherein said three dimensional structuring element [500] is unidirectional in a temporal dimension to accommodate unidirectional motion estimation.

27. A digitally encoded video signal as claimed in claim 19 wherein said method further comprises the step of locating significant wavelet coefficients in at least one cluster of significant wavelet coefficients across space and time in a direction of motion.
